(19) United States
(12) Patent Application Publication
(10) Pub. No.: US 2018/0039955 A1
(43) Pub. Date: Feb. 8, 2018

(54) MEETING TIME POLLING

(71) Applicant: MICROSOFT TECHNOLOGY LICENSING, LLC, Redmond, WA (US)

(72) Inventors: Mark Daniel MacKenzie, Seattle, WA (US); Hiroshi Tsukahara, Bellevue, WA (US); Philipp Cannons, Redmond, WA (US)

(73) Assignee: MICROSOFT TECHNOLOGY LICENSING, LLC, Redmond, WA (US)

(21) Appl. No.: 15/367,000

(22) Filed: Dec. 1, 2016

Related U.S. Application Data
(60) Provisional application No. 62/371,858, filed on Aug. 8, 2016.

(51) Int. Cl. G06Q 10/10

(52) U.S. Cl. CPC G06Q 10/1095

(57) ABSTRACT

Variety of approaches to provide time polling are described. A calendar application initiates operations to provide meeting time polling upon processing an availability information associated with a meeting organizer and/or a meeting invitee to provide suggested timeslot(s). Selected timeslot(s) are received as a selection from the suggested timeslot(s) by the meeting organizer. The selected timeslots are transmitted to the meeting invitee for prompting the meeting invitee for a vote. Next, voted timeslots are received as a selection from the selected timeslot(s) by the meeting invite. The voted timeslot(s) are provided to the meeting organizer for prompting the meeting organizer to finalize the meeting.

### CROSS-REFERENCE TO RELATED APPLICATIONS

This Application claims the benefit under 35 U.S.C. § 119(e) of U.S. Provisional Patent Application Ser. No. 62/371,858 filed on Aug. 8, 2016. The disclosure of the U.S. Provisional patent application is hereby incorporated by reference in its entirety.

### BACKGROUND

Information collection, management, and analysis have changed work processes and associated time management. Automation and improvements in work processes have expanded scope of capabilities offered by businesses. With the development of faster and smaller electronics, execution of mass processes at data analysis systems have become feasible. Indeed, analysis work at data centers, data warehouses, data workstations have become common experience in modern work and personal environments. Such systems provide a wide variety of applications such as calendar applications managing time resources. Many such applications provide time resource management to manage tasks, events, and meetings. Meeting management consume significant resources and performance at a promise of improved time based resource management and condensed task flows.

Improved meeting management techniques are becoming ever more important as time based resource management complexity increases across the computer industry. Variety of techniques are necessary to setup a meeting and to hold the meeting. There are currently significant gaps when providing meeting organization coordination and when providing tools to setup a meeting. Lack of relevant meeting organization methods in relation to a meeting invitees lead to poor management of the meeting.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to meeting time polling. A calendar application, according to embodiments, may initiate operations to provide meeting time polling by providing suggested timeslot(s) for a meeting by processing an availability information associated with a meeting organizer and a meeting invitee. Next, selected timeslot(s) may be received from the meeting organizer as a first selection from the suggested timeslot(s). The selected timeslot(s) may be transmitted to the meeting invitee for prompting the meeting invitee for a vote. Voted timeslot(s) may be received from the meeting invitee as a second selection from the selected timeslot(s). The voted timeslot(s) may be provided to the meeting organizer for prompting the meeting organizer to finalize the meeting.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing meeting time polling, according to embodiments;

FIG. 2 is a display diagram illustrating example components of a user interface of a calendar application that provides meeting time polling, according to embodiments;

FIG. 3 is a display diagram illustrating an example of a meeting invitee interacting with a user interface of a calendar application providing meeting time polling, according to embodiments;

FIG. 4 is a display diagram illustrating an example of a meeting organizer interacting with a user interface of a calendar application providing meeting time polling, according to embodiments;

FIG. 5 is a simplified networked environment, where a system according to embodiments may be implemented;

FIG. 6 is a block diagram of an example computing device, which may be used to provide meeting time polling, according to embodiments; and

FIG. 7 is a logic flow diagram illustrating a process for providing meeting time polling, according to embodiments.

### DETAILED DESCRIPTION

As briefly described above, a calendar application may provide suggested timeslot(s) for a meeting by processing an availability information associated with a meeting organizer and/or a meeting invitee. The availability information may be retrieved from calendar provider(s) associated with the meeting organizer and/or the meeting invitee which may or may not be the same entity. Alternatively, the calendar provider associated with the meeting invitee may be prompted to have the meeting invitee grant an access to the availability information associated with the meeting invitee.

Next, selected timeslot(s) may be received from the meeting organizer as a selection from the suggested timeslot(s). The selected timeslot(s) may be used as options to pole the meeting invitee for meeting timeslot(s). The selected timeslot(s) may be transmitted to the meeting invitee for prompting the meeting invitee for a vote. Variety of communication modalities may be used to present the meeting invitee with the selected timeslot(s). A communication such as an email may be populated with the selected timeslot(s) and a voting element to prompt the meeting invitee to vote on the selected timeslot(s). Alternatively, another user interface may be provided to the meeting invitee for an interaction associated with the vote.

Voted timeslot(s) may be received from the meeting invitee as a selection from the selected timeslot(s). The voted timeslot(s) may be provided to the meeting organizer for prompting the meeting organizer to finalize the meeting. In response to a selection by the meeting organizer from the voted timeslot(s), the meeting may be generated based on the selection from the voted timeslot(s).

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide meeting time polling. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

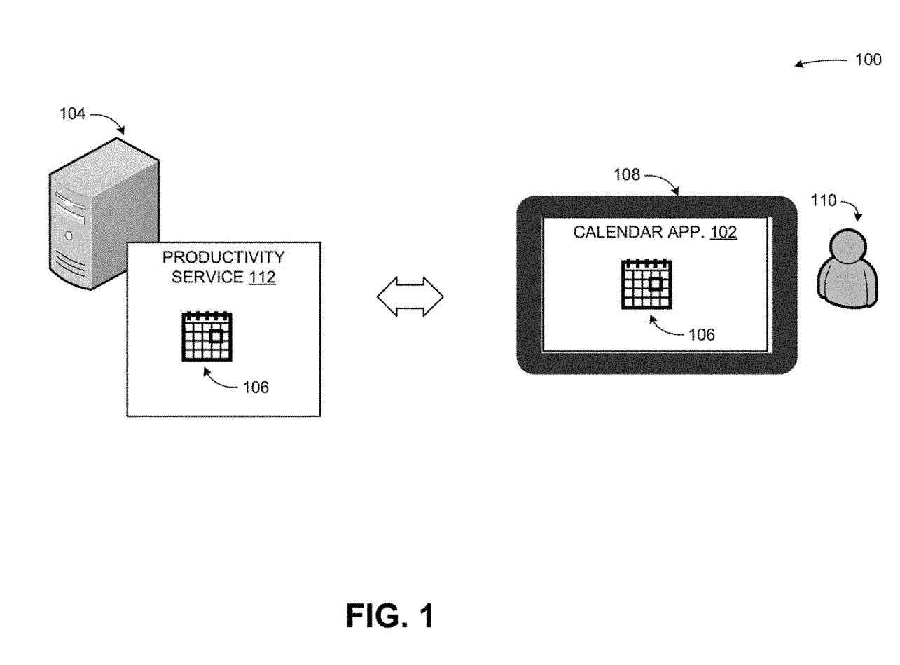

FIG. 1 is a conceptual diagram illustrating examples of providing meeting time polling, according to embodiments.

In a diagram 100, a computing device 108 may execute a calendar application 102. The computing device 108 may include a physical computer and/or a mobile computing device such as a smart phone and/or similar ones. The computing device 108 may also include a special purpose and/or configured device that is optimized to execute data operations associated with the calendar application 102. For example, the computing device 108 may include physical components that are custom built to accelerate operations associated with a meeting with multiple computation cores tailored to process number of data streams associated with the meeting.

The computing device 108 may execute the calendar application 102. The calendar application 102 may initiate operations to provide meeting time polling by providing suggested timeslot(s) for a meeting 106 by processing an availability information associated with a meeting organizer 110 and/or a meeting invitee. The availability information may be retrieved from calendar provider(s) associated with the meeting organizer 110 and/or the meeting invitee which may or may not be the same entity. Alternatively, the calendar provider associated with the meeting invitee may be prompted to have the meeting invitee grant an access to the availability information associated with the meeting invitee.

Next, selected timeslot(s) may be received from the meeting organizer 110 as a selection from the suggested timeslot(s). The selected timeslot(s) may be used as options to pole the meeting invitee for meeting timeslot(s). The selected timeslot(s) may be transmitted to the meeting invitee for prompting the meeting invitee for a vote. Variety of communication modalities may be used to present the meeting invitee with the selected timeslot(s). A communication such as an email may be populated with the selected timeslot(s) and a voting element to prompt the meeting invitee to vote on the selected timeslot(s). Alternatively, another user interface may be provided to the meeting invitee for an interaction associated with the vote.

Voted timeslot(s) may be received from the meeting invitee as a selection from the selected timeslot(s). The voted timeslot(s) may be provided to the meeting organizer 110 for prompting the meeting organizer 110 to finalize the meeting 106. In response to a selection by the meeting organizer 110 from the voted timeslot(s), the meeting 106 may be generated based on the selection from the voted timeslot(s).

The computing device 108 may communicate with other client device(s) or server(s) through a network. The network may provide wired or wireless communications between network nodes such as the computing device 108, other client device(s) and/or server(s) such as the calendar provider 104, among others. Previous example(s) to provide a meeting time polling by the calendar application 102 are not provided in a limiting sense. Alternatively, a productivity service 112 may provide meeting time polling. Furthermore, the productivity service 112 may provide the calendar application 102 as a client interface (or a user interface) for execution by the computing device 108.

The meeting organizer 110 may interact with the calendar application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the calendar application 102, embodiments are not limited to these components or system configurations and can be implemented with other system configuration employing fewer or additional components.

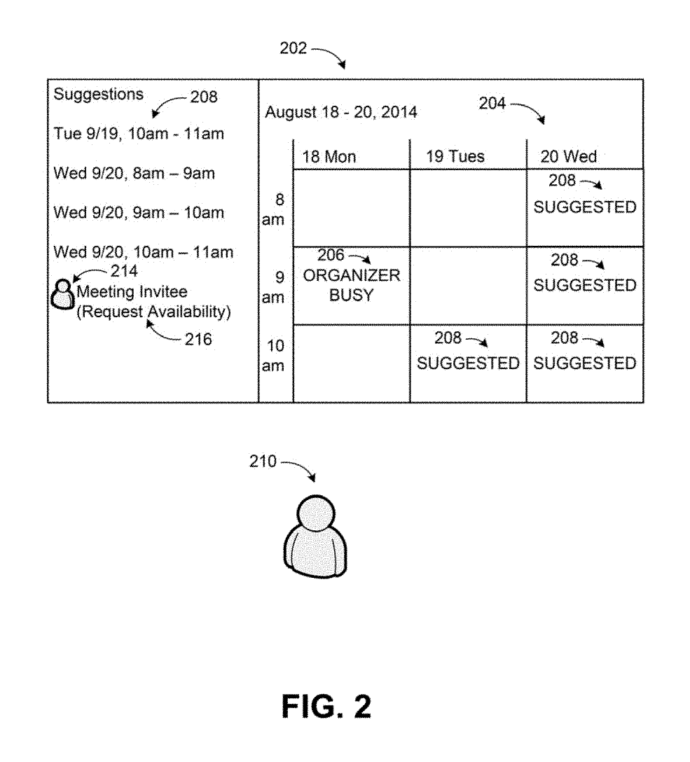

FIG. 2 is a display diagram illustrating example components of a user interface of a calendar application that provides meeting time polling, according to embodiments.

In a diagram 200, a scheduling module of a calendar application 202 may provide meeting time polling. The calendar application 202 may provide a user interface (UI) to a meeting organizer 210 to aid in setting up a meeting. The meeting organizer 210 may interact with the UI of the calendar application 202 to setup the meeting.

In an example scenario, the meeting organizer 210 may not have access to availability information associated with a meeting invitee 214. For example, the meeting invitee may choose to configure the availability information inaccessible for privacy and/or other reasons. If the meeting organizer 210 is unable to access availability information associated with the meeting invitee 214, the meeting organizer 210 may desire to provide meeting timeslot options to prompt the meeting invitee 214 to select a meeting timeslot for the meeting.

Alternatively, the meeting organizer 210 may have access to the availability information associated with the meeting invitee 214. The meeting organizer 210 may still desire to provide meeting timeslot options to the meeting invitee to receive an input from the meeting invitee 214 for desired timeslot(s) for the meeting. To aid the meeting organizer 210, the calendar application 202 may provide meeting time polling features.

The meeting organizer 210 may request a permission to access the availability information of the meeting invitee 214 by activating a request availability element 216. The request availability element 216 may include operations to interact with a calendar provider and/or the meeting invitee 214 to access the availability information associated with the meeting invitee 214. If the calendar provider and/or the meeting invitee 214 grants access to the availability information associated with the meeting invitee 214, the availability information may be processed to identify shared available timeslot(s) as the suggested timeslot(s) 208.

In an example scenario, the meeting organizer 210 may identify meeting properties such as a title and meeting invitee(s). The calendar application 202 may have access the availability information associated with the meeting organizer 210. Alternatively, the calendar application 202 may attempt to access the availability information associated with the meeting invitee. The availability information may identify a busy timeslot 206 and availability timeslot(s) in a time range selected by the meeting organizer 210. The availability information for the meeting organizer 210 and the meeting invitee 214 may be provided from calendar provider(s) that may or may not be the same entity. Furthermore, the calendar application 202 may also be executed by the calendar provider that may reside in a separate physical computing device.

If the availability information associated with the meeting invitee is accessible, the calendar application 202 may process the availability information associated with the meeting organizer 210 and the meeting invitee 214 to identify shared available timeslots. In such a scenario, the shared available timeslots may be provided to the meeting organizer 210 as suggested timeslots 208. If the availability information associated with the meeting is inaccessible, the calendar application 202 may provide available timeslot(s) in the availability information associated with the meeting organizer 210 as the suggested timeslots 208.

The meeting organizer 210 may select some or all of the suggested timeslots 208 and transmit the selected timeslot(s) to the meeting invitee for a vote. In an example scenario, the suggested timeslots 208 may be inserted into a communication (such as an email) along with a voting element to prompt the meeting invitee 214 to select from the suggested timeslots 208 as timeslot option(s) for the meeting. Alternatively, the calendar application 202 may provide the suggested timeslots 208 to the meeting invitee in other UI presented to the meeting invitee 214.

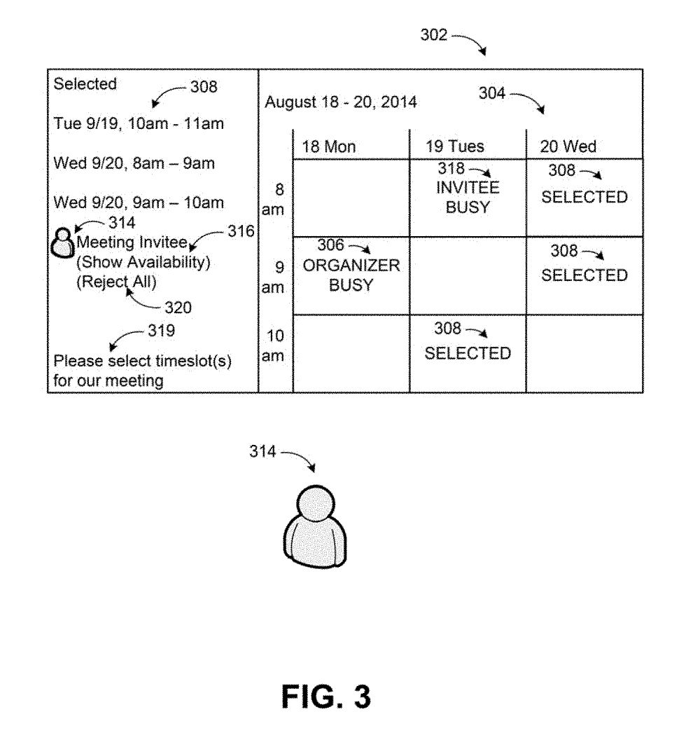

FIG. 3 is a display diagram illustrating an example of a meeting invitee interacting with a user interface of a calendar application providing meeting time polling, according to embodiments.

In a diagram 300, a scheduling module of a calendar application 302 may present selected timeslots 308 to a meeting invitee 314. A meeting organizer may choose the selected timeslots 308 from shared available timeslots (in common with a meeting invitee) autosuggested by the calendar application 302. The selected timeslots 308 may be presented to the meeting invitee in a user interface used to interact with the meeting invitee.

The calendar application may present controls to allow the meeting invitee 314 to select some, all, or none of the selected timeslots as a timeslot for the meeting. For example, the meeting invitee 314 may interact with the user interface of the calendar application 302 to select some of the selected timeslots 308 as options for the meeting timeslot. Alternatively, the meeting invitee 314 may interact with the user interface to select all of the selected timeslots 308 as options for the meeting timeslot.

Furthermore, the meeting invitee may select the reject all element 320 to reject the selected timeslots 308. Upon activation, the reject all element 320 may execute operations to transmit a message notifying the meeting organizer of the rejection of the selected timeslots 308 by the meeting invitee 314. Alternatively, upon detecting activation of the reject all element 320, the calendar application may cancel the meeting invite and notify the meeting organizer of the cancellation if the meeting invitee 314 is the sole attendee of the meeting. Moreover, the calendar application may interact with the meeting invitee 314 (upon detecting activation of the reject all element 320) to prompt the meeting invitee to select alternative timeslots to hold the meeting. Any selected alternative timeslots may be provided to the meeting organizer for setting up the meeting.

The calendar application 302 may also present a busy timeslot 306 associated with the meeting organizer to inform the meeting invitee. The busy timeslot 306 may be provided to prevent the meeting invitee to select the busy timeslot 306 as an alternative timeslot (in case of a rejection of the selected timeslots 308).

In another example scenario, the calendar application 302 may present a notification 319 for informing the meeting invitee 314 to select some, all, or none of the selected timeslots 308 as options for the meeting timeslot. Furthermore, the calendar application 302 may present a show availability element 316 within the user interface to prompt the meeting invitee to grant access to the availability information associated with the meeting invitee. The show availability element 316 may be provided to allow the meeting invitee 314 to respond to an access request by the meeting organizer (or provide the access without a request). If the meeting invitee 314 grants access to the availability information, the calendar application 302 may display a busy timeslot 318 associated with the meeting invitee 314 to the meeting organizer. In such a scenario, the calendar application may use the access to the availability information associated with the meeting invitee 314 to process the availability information associated with the meeting organizer and the meeting invitee 314 to generate shared available timeslots as suggested timeslots.

If the meeting invitee 314 fails to select some, all, or none of the selected timeslots 308, the calendar application 302 may notify the meeting invitee 314 to remind for a vote (or a selection). The calendar application 302 may provide the notification automatically upon an approaching timeslot threshold. For example, in response to a proximity to a nearest timeslot from the selected timeslots 308, the calendar application 302 may remind the meeting invitee 314 to make a selection.

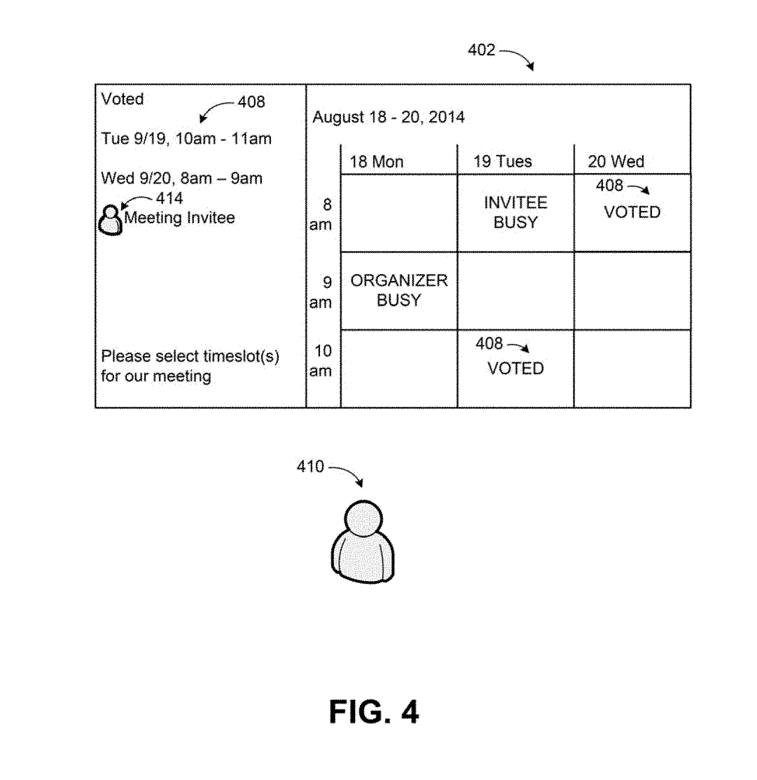

FIG. 4 is a display diagram illustrating an example of a meeting organizer interacting with a user interface of a calendar application providing meeting time polling, according to embodiments.

In a diagram 400, a scheduling module of the calendar application 402 may receive voted timeslots 408 from the meeting invitee 414. The voted timeslots 408 may be presented to the meeting organizer 410 on a user interface used by the meeting organizer 410 to interact with the calendar application 402. If the calendar application 402 receives a single timeslot as a voted timeslot, the calendar application 402 may automatically finalize the meeting and setup the meeting timeslot based on the single timeslot. The meeting may be inserted into a calendar associated with the meeting organizer 410. The calendar application 402 may also instruct a calendar provider associated with the meeting invitee 414 to insert the meeting into the calendar associated with the meeting invitee 414.

The meeting may also be finalized in response to a selection from the meeting organizer 410 from the voted timeslots 408. Furthermore, the meeting timeslot may be selected automatically from the voted timeslots 408 based on a contextual information associated with the meeting organizer or the meeting invitee. For example, the presence information associated with the meeting invitee 414 (or the meeting organizer) prior (or after) a voted timeslot may be considered while determining one of the voted timeslots 408 for the meeting timeslot. A travel distance and/or other attributes associated with the meeting invitee (or the meeting organizer) may be considered while selecting the meeting timeslot from the voted timeslots 408.

As discussed above, the calendar application may be employed to provide meeting time polling. An increased user efficiency with the calendar application 102 may occur as a result of automatically identifying meeting timeslot options through meeting time polling and interacting with the meeting organizer and/or meeting invitee for selections associated with the meeting timeslot options. As such, automated meeting time polling may reduce processor load, increase processing speed, conserve memory, and reduce network bandwidth usage.

Embodiments, as described herein, address a need that arises from a lack of efficiency to provide a meeting time polling. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing meeting time polling may be implemented in configurations employing fewer or additional components in applications and user interfaces. Furthermore, the example schema and components shown in FIG. 1 through 4 and their subcomponents may be implemented in a similar manner with other values using the principles described herein.

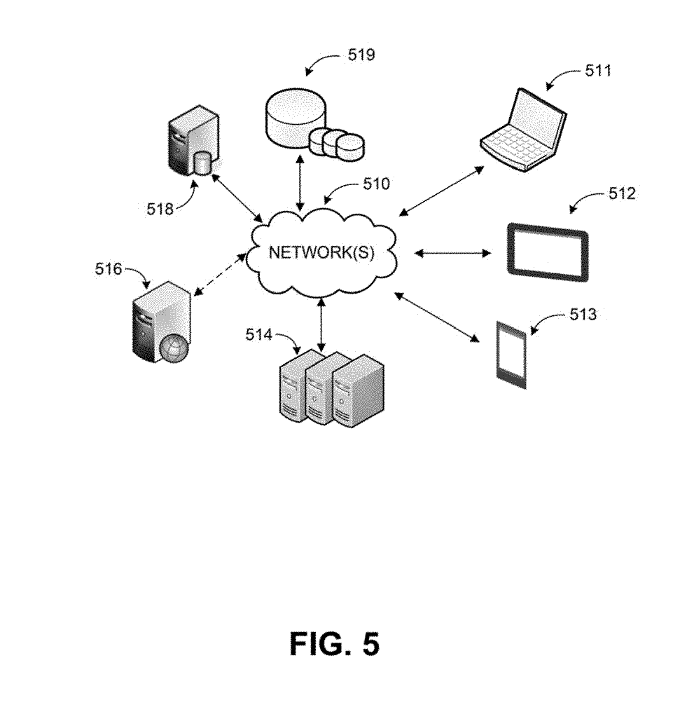

FIG. 5 is an example networked environment, where embodiments may be implemented. A calendar application configured to provide meeting time polling may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A calendar application may provide suggested timeslots for a meeting by processing an availability information associated with a meeting organizer and/or a meeting invitee. Selected timeslots may be received as a selection from suggested timeslots by the meeting organizer. The selected timeslots may be transmitted to the meeting invitee for prompting the meeting invitee for a vote. Next, voted timeslots may be received as a selection from the selected timeslots by the meeting invite. The voted timeslots may be provided to the meeting organizer for prompting the meeting organizer to finalize the meeting. The calendar application may store data associated with the meeting invite in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide meeting time polling. Furthermore, the networked environments discussed in FIG. 5 are for illustration purposes only. Embodiments are not limited to the example applications, modules, or processes.

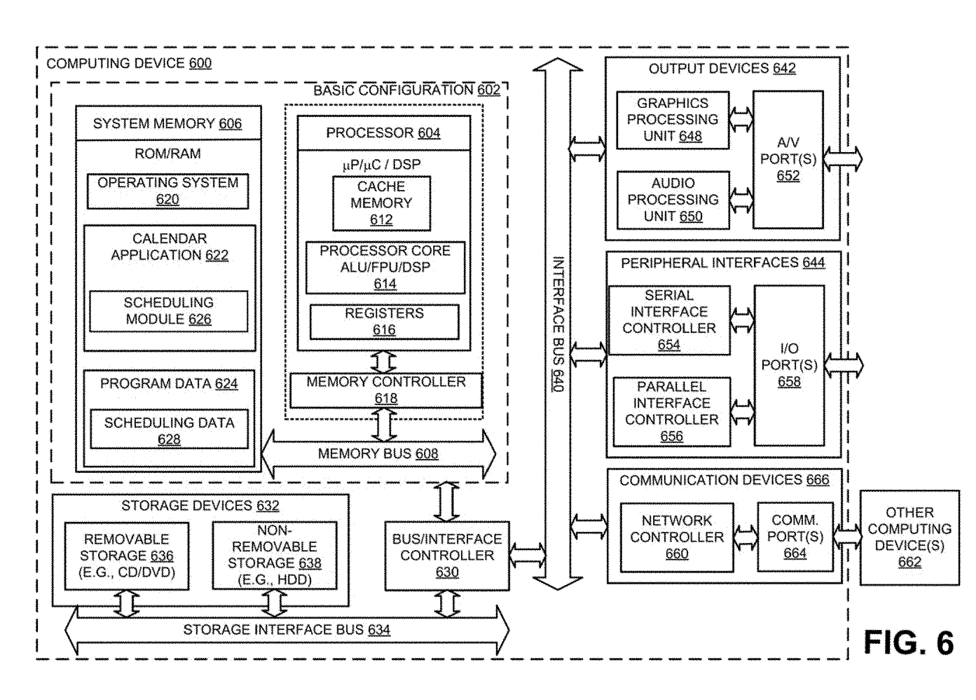

FIG. 6 is a block diagram of an example computing device, which may be used to provide meeting time polling, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a calendar application 622, and a program data 624. The calendar application 622 may include components such as a scheduling module 626. The scheduling module 626 may execute the processes associated with the calendar application 622. The scheduling module 626 may provide suggested timeslots for a meeting by processing an availability information associated with a meeting organizer and/or a meeting invitee. Selected timeslots may be received as a selection from suggested timeslots by the meeting organizer. The selected timeslots may be transmitted to the meeting invitee for prompting the meeting invitee for a vote. Next, voted timeslots may be received as a selection from the selected timeslots by the meeting invite. The voted timeslots may be provided to the meeting organizer for prompting the meeting organizer to finalize the meeting.

The calendar application 622 may communicate availability information associated with the meeting organizer and the meeting invitee through a communication component associated with the computing device 600. An example of the communication component may include a communication device 666 (among others) that may be communicatively coupled to the computing device 600. The program data 624 may also include, among other data, scheduling data 628, or the like, as described herein. The scheduling data 628 may include the availability information and meeting timeslot(s).

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interlaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or as more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable, media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide meeting time polling. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

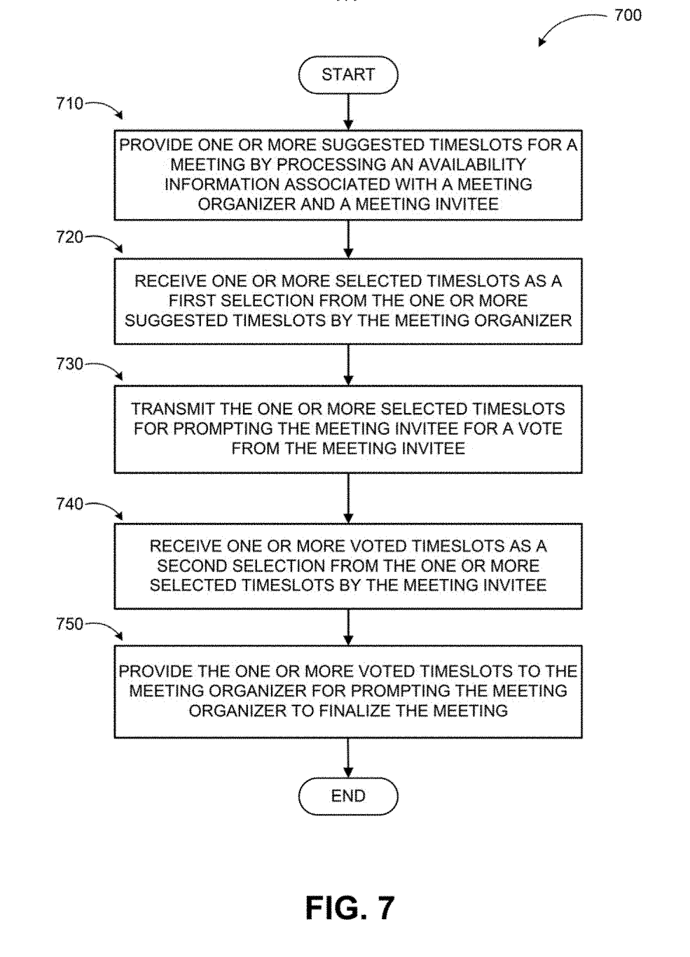

FIG. 7 is a logic flow diagram illustrating a process for providing meeting time polling, according to embodiments. Process 700 may be implemented on a computing device, such as the computing device 600 or another system.

Process 700 begins with operation 710, where the calendar application provides suggested timeslots for a meeting. The suggested timeslots re identified by processing an availability information associated with a meeting organizer and/or a meeting invitee. Next, at operation 720, selected timeslot(s) may be received as a selection from the suggested timeslot(s) by the meeting organizer. The meeting organizer may select some, all, or none of the suggested timeslot(s) for the selected timeslot(s). In case of a rejection of the suggested timeslot(s), alternative timeslot(s) provided by the meeting organizer may be designated as the selected timeslot(s).

At operation 730, the selected timeslot(s) may be transmitted to the meeting invitee. The meeting invitee may be prompted for a vote for a selection from the selected timeslot(s). At operation 740, voted timeslot(s) may be received as a selection from the selected timeslot(s) by the meeting invitee. The voted timeslot(s) may be provided to the meeting organizer for prompting the meeting organizer to finalize the meeting at operation 750.

The operations included in process 700 are for illustration purposes. Providing meeting time polling may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to provide meeting time polling is described. The computing device includes a communication component, a memory configured to store instructions associated with a calendar application, and a processor coupled to the memory and the communication component. The processor executes the calendar application in conjunction with the instructions stored in the memory. The calendar application includes a scheduling module. The scheduling module is configured to provide one or more suggested timeslots for a meeting by processing an availability information associated with a meeting organizer and a meeting invitee, receive, through the communication component, one or more selected timeslots as a first selection from the one or more suggested timeslots by the meeting organizer, transmit, through the communication component, the one or more selected timeslots to the meeting invitee for prompting the meeting invitee for a vote, receive, through the communication component, one or more voted timeslots as a second selection from the one or more selected timeslots by the meeting invitee, and provide the one or more voted timeslots to the meeting organizer for prompting the meeting organizer to finalize the meeting.

In other examples, the scheduling module is further configured to retrieve the availability information associated with the meeting organizer and the meeting invitee from one or more calendar provider, identify one or more shared available timeslots within the availability information associated with the meeting organizer and the meeting invitee, and provide the one or more shared availability timeslots as the one or more suggested timeslots for the meeting. The scheduling module is further configured to in response to a failure to retrieve the availability information associated with the meeting invitee, provide one or more available timeslots within the availability information associated with the meeting organizer as the one or more suggested timeslots for the meeting. Transmitting one or more selected timeslots for the vote includes one or more operations to generate an email that includes the one or more selected timeslots and insert a voting element into the email for prompting the meeting invitee to provide the one or more voted timeslots.

In further examples, the scheduling module is further configured to receive, through the communication component, a rejection of the one or more selected timeslots from the meeting invitee and remove the meeting invitee from the meeting. The scheduling module is further configured to receive, through the communication component, a rejection of the one or more selected timeslots from the meeting invitee, receive, through the communication component, one or more new selected timeslots from the meeting invitee, and designate the one or more new selected timeslots as the one or more voted timeslots.

In other examples, transmitting the one or more selected timeslots for the vote includes one or more operations to instruct a calendar provider associated with the meeting invitee to insert the one or more selected timeslots as one or more tentative timeslots into a calendar associated with the meeting invitee. The scheduling module is further configured to in response to receiving the one or more voted timeslots, instruct the calendar provider to replace the one or more tentative timeslots within the calendar associated with the meeting invitee with the one or more voted timeslots. The scheduling response is further configured to detect a third selection of a meeting timeslot as the meeting from the one or more voted timeslots by the meeting organizer, instruct the calendar provider to remove the one or more tentative timeslots from the calendar, and instruct the calendar provider to insert the meeting timeslot as the meeting into the calendar.

In further examples, the scheduling module is further configured to detect a failure to receive the one or more voted timeslots from the meeting invitee and transmit, through the communication component, a notification to the meeting invitee to remind the meeting invitee to provide the vote for the second selection from the one or more selected timeslots. The scheduling module is further configured to transmit, through the communication component, a request to a calendar provider associated with the meeting invitee to send the availability information associated with the meeting invitee and receive, through the communication component, the availability information associated with the meeting invitee from the calendar provider.

In some examples, a method executed on a computing device to provide meeting time polling is described. The method includes presenting one or more suggested timeslots for a meeting by processing an availability information associated with a meeting organizer and a meeting invitee, receiving one or more selected timeslots as a first selection from the one or more suggested timeslots by the meeting organizer, transmitting a first email that includes the one or more selected timeslots provided for receiving a vote from the meeting invitee, receiving a second email that includes one or more voted timeslots as a second selection from the one or more selected timeslots by the meeting invitee, and presenting the one or more voted timeslots to the meeting organizer for prompting the meeting organizer to finalize the meeting.

In other examples, the method further includes detecting a failure to select a meeting timeslot as the meeting from the one or more voted timeslots by the meeting organizer and transmitting a notification to the meeting organizer to remind the meeting organizer to select the meeting timeslot from the one or more voted timeslots. The failure to select the meeting timeslot is detected within a duration threshold of a closest timeslot from the one or more voted timeslots. The method further includes detecting a single timeslot as the one or more voted timeslots and automatically finalizing the meeting based on the single timeslot. The method further includes inserting the meeting into a calendar associated with the meeting organizer and transmitting an instruction to a calendar provider associated with the meeting invitee to insert the meeting into the calendar associated with the meeting invitee. The method further includes selecting a meeting timeslot from the one or more voted timeslots base on a contextual information associated with one or more of the meeting organizer and the meeting invitee and automatically finalizing the meeting based on the meeting timeslot.

In some examples, a computer-readable memory device with instructions stored thereon to provide meeting time polling is described. The instructions include actions that are similar to the actions of the method.

In other examples, the instructions further include retrieving an information associated with other meeting invitee from a calendar provider associated with the other meeting invitee, processing an availability information associated with the other meeting invitee, and identifying one or more available timeslots associated with the other meeting invitee from the availability information. The instructions further include selecting a subset of the one or more suggested timeslots that match the one or more available timeslots and providing the subset of the one or more suggested timeslots to the meeting organizer for the first selection.

In some examples, a means for providing meeting time polling is described. The means for providing meeting time polling include a means for providing one or more suggested timeslots for a meeting by processing an availability information associated with a meeting organizer and a meeting invitee, a means for receiving one or more selected timeslots as a first selection from the one or more suggested timeslots by the meting organizer, a means for transmitting the one or more selected timeslots to the meeting invitee for prompting the meeting invitee for a vote, a means for receiving one or more voted timeslots as a second selection from the one or more selected timeslots by the meeting invitee, and a means for providing the one or more voted timeslots to the meeting organizer for prompting the meeting organizer to finalize the meeting.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide meeting time polling, the computing device comprising:
a communication component;
a memory configured to store instructions associated with a calendar application;
a processor coupled to the memory and the communication component, the processor executing the calendar application in conjunction with the instructions stored in the memory, wherein the calendar application includes:
a scheduling module configured to:
provide one or more suggested timeslots for a meeting by processing an availability information associated with a meeting organizer and a meeting invitee;
receive, through the communication component, one or more selected timeslots as a first selection from the one or more suggested timeslots by the meeting organizer;
transmit, through the communication component, the one or more selected timeslots to the meeting invitee for prompting the meeting invitee for a vote;
receive, through the communication component, one or more voted timeslots as a second selection from the one or more selected timeslots by the meeting invitee; and
provide the one or more voted timeslots to the meeting organizer for prompting the meeting organizer to finalize the meeting.

2. The computing device of claim 1, wherein the scheduling module is further configured to:
retrieve the availability information associated with the meeting organizer and the meeting invitee from one or more calendar provider;
identify one or more shared available timeslots within the availability information associated with the meeting organizer and the meeting invitee; and
provide the one or more shared timeslots as the one or more suggested timeslots for the meeting.

3. The computing device of claim 1, wherein the scheduling module is further configured to:
in response to a failure to retrieve the availability information associated with the meeting invitee, provide one or more available timeslots within the availability information associated with the meeting organizer as the one or more suggested timeslots for the meeting.

4. The computing device of claim 1, wherein transmitting one or more selected timeslots for the vote includes one or more operations to:
generate an email that includes the one or more selected timeslots; and
insert a voting element into the email for prompting the meeting invitee to provide the one or more voted timeslots.

5. The computing device of claim 1, wherein the scheduling module is further configured to:
receive, through the communication component, a rejection of the one or more selected timeslots from the meeting invitee; and
remove the meeting invitee from the meeting.

6. The computing device of claim 1, wherein the scheduling module is further configured to:
receive, through the communication component, a rejection of the one or more selected timeslots from the meeting invitee;
receive, through the communication component, one or more new selected timeslots from the meeting invitee; and
designate the one or more new selected timeslots as the one or more voted timeslots.

7. The computing device of claim 1, wherein transmitting the one or more selected timeslots for the vote includes one or more operations to:
instruct a calendar provider associated with the meeting invitee to insert the one or more selected timeslots as one or more tentative timeslots into a calendar associated with the meeting invitee.

8. The computing device of claim 7, wherein the scheduling module is further configured to:
in response to receiving the one or more voted timeslots,
instruct the calendar provider to replace the one or more tentative timeslots within the calendar associated with the meeting invitee with the one or more voted timeslots.

9. The computing device of claim 7, wherein the scheduling module is further configured to:
detect a third selection of a meeting timeslot as the meeting from the one or more voted timeslots by the meeting organizer;
instruct the calendar provider to remove the one or more tentative timeslots from the calendar; and
instruct the calendar provider to insert the meeting timeslot as the meeting into the calendar.

10. The computing device of claim 1, wherein the scheduling module is further configured to:
detect a failure to receive the one or more voted timeslots from the meeting invitee; and
transmit, through the communication component, a notification to the meeting invitee to remind the meeting invitee to provide the vote for the second selection from the one or more selected timeslots.

11. The computing device of claim 1, wherein the scheduling module is further configured to:
transmit, through the communication component, a request to a calendar provider associated with the meeting invitee to send the availability information associated with the meeting invitee; and
receive, through the communication component, the availability information associated with the meeting invitee from the calendar provider.

12. A method executed on a computing device to provide meeting time polling, the method comprising:
presenting one or more suggested timeslots for a meeting by processing an availability information associated with a meeting organizer and a meeting invitee;
receiving one or more selected timeslots as a first selection from the one or more suggested timeslots by the meeting organizer;
transmitting a first email that includes the one or more selected timeslots provided for receiving a vote from the meeting invitee;
receiving a second email that includes one or more voted timeslots as a second selection from the one or more selected timeslots by the meeting invitee; and
presenting the one or more voted timeslots to the meeting organizer for prompting the meeting organizer to finalize the meeting.

13. The method of claim 12, further comprising:
detecting a failure to select a meeting timeslot as the meeting from the one or more voted timeslots by the meeting organizer; and
transmitting a notification to the meeting organizer to remind the meeting organizer to select the meeting timeslot from the one or more voted timeslots.

14. The method of claim 13, wherein the failure to select the meeting timeslot is detected within a duration threshold of a closest timeslot from the one or more voted timeslots.

15. The method of claim 12, further comprising:
detecting a single timeslot as the one or more voted timeslots; and
automatically finalizing the meeting based on the single timeslot.

16. The method of claim 15, further comprising:
inserting the meeting into a calendar associated with the meeting organizer; and
transmitting an instruction to a calendar provider associated with the meeting invitee to insert the meeting into the calendar associated with the meeting invitee.

17. The method of claim 12, further comprising:
selecting a meeting timeslot from the one or more voted timeslots base on a contextual information associated with one or more of the meeting organizer and the meeting invitee; and
automatically finalizing the meeting based on the meeting timeslot.

18. A computer-readable memory device with instructions stored thereon to provide meeting time polling, the instructions comprising:
presenting one or more suggested timeslots for a meeting by processing an availability information associated with a meeting organizer and a meeting invitee;
receiving one or more selected timeslots as a first selection from the one or more suggested timeslots by the meeting organizer;
transmitting a first email that includes the one or more selected timeslots provided for receiving a vote from the meeting invitee;
receiving a second email that includes one or more voted timeslots as a second selection from the one or more selected timeslots by the meeting invitee; and
presenting the one or more voted timeslots to the meeting organizer for prompting the meeting organizer to finalize the meeting.

19. The computer-readable memory device of claim 18, wherein the instructions further comprise:
retrieving an availability information associated with other meeting invitee from a calendar provider associated with the other meeting invitee;
processing an availability information associated with the other meeting invitee; and
identifying one or more available timeslots associated with the other meeting invitee from the availability information.

20. The computer-readable memory device of claim 19, wherein the instructions further comprise:
selecting a subset of the one or more suggested timeslots that match the one or more available timeslots; and
providing the subset of the one or more suggested timeslots to the meeting organizer for the first selection.
